(19) United States
(12) Patent Application Publication
(10) Pub. No.: US 2005/0106938 A1
(43) Pub. Date: May 19, 2005

(54) On-board connector, mating connector adapted to make a connection with the on-board connector, and connector apparatus equipped with the on-board connector and the mating connector

(76) Inventors: Atsushi Nishio, Ibaraki (JP); Takashi Kawasaki, Ibaraki (JP); Satoru Karahashi, Ibaraki (JP)

Correspondence Address: PATENTS+TMS;A Professional Corporation, 1914 North Milwaukee Avenue, Chicago, IL, 60647, US

(21) Appl. No.: 10/931,339

(22) Filed: Aug. 31, 2004

(30) Foreign Application Priority Data
Nov. 19, 2003 (JP) 2003-389675

(51) Int. Cl. H01R 13/648

(52) U.S. Cl. 439/607

(57) ABSTRACT

A connector socket (on-board connector) 1a includes a shield case 11 which covers part or all of an IC 31 provided on a substrate 3 near a position where the connector socket is mounted so that the shield case 11 promotes heat radiation from the IC 31 and provides electromagnetic shielding to the IC 31. Further, a connector plug (mating connector) 2a includes a plug portion 26 and a plug shield 23 arranged the outside of the connector plug 2a. The plug shield 23 is connected to a braided shield 25 of a connector cable 22 by a caulk 24.

This application claims the benefit of Japanese Patent Application No.: 2003-389675, filed Nov. 19, 2003.

### BACKGROUND OF THE INVENTION

1. Field of the Invention

The present invention is related to an on-board connector to be mounted on a substrate at a position near a heat generating element provided on the substrate, a mating connector adapted to make a connection with the on-board connector, and a connector apparatus equipped with the on-board connector and the mating connector.

2. Description of the Prior Art

An example of a prior art connector apparatus is shown in FIG. 2. This connector apparatus is constructed from an on-board connector (connector socket) 1 mounted on a substrate 3, and a mating connector (connector plug) 2 which is adapted to make a connection with the connector socket 1. Further, an IC 31 which is a heat generating element such as a CPU or a motor driver IC or the like which generates high heat is also mounted on the substrate 3 provided with the connector socket 1. On the other hand, a connector cable 22 is connected to the connector plug 2. One example of this kind of prior art structure is disclosed in Japanese Laid-Open Patent Application Publication No. 2000-138465.

However, in the prior art structure described above, the heat generated by the IC 31 hinders the stable operation of the IC 31 itself. In particular, in the case where the substrate 3 is provided inside a closed casing of a personal computer or an optical disc drive or the like, because the temperature inside the casing rises, it is not possible to ensure sufficient heat radiation of the IC 31. For this reason, a heat radiating plate or cooling fan or the like needs to be provided to promote heat radiation of the IC 31. However, this approach creates another problem such as a higher manufacturing cost. Further, in order to prevent electromagnetic interference to the IC 31, a shield case which covers the IC 31 needs to be provided separately.

### SUMMARY OF THE INVENTION

In view of the problems described above, it is an object of the present invention to provide an on-board connector which can promote heat radiation of a heat generating element without the need to separately provide a shield case for preventing electromagnetic inference, a mating connector adapted to make a connection with the on-board connector, and a connector apparatus equipped with the on-board connector and the mating connector.

In order to achieve the object, the present invention is directed to an on-board connector which is adapted to be mounted on a substrate on which at least one heat generating element is provided near a position where the on-board connector is to be mounted. The on-board connector comprises a plurality of terminals; a connector housing which houses the terminals; and a shield case which covers part or all of the heat generating element when the connector is mounted on the substrate.

As described above, since the on-board connector according to the present invention includes the shield case which covers part or all of the heat generating element provided on the substrate near a position where the connector is to be mounted, it is possible to diffuse and radiate heat generated from the heat generating element by the shield case.

In the connector according to the present invention, it is preferred that the shield case is formed from a metallic material, and the shield case is integrally formed with the connector housing. Further, it is also preferred that the shield case is formed from a metallic material as a separate component from the connector housing, and the shield case is provided in contact with the connector housing. According to these structures, the shield case can function as an electromagnetic shield for the heat generating element. Further, since a part of the on-board connector is used as a shield case, it is not necessary to separately provide a heat radiation means or an electromagnetic shield means for the heat generating element, thereby enabling to reduce a number of components to be used.

Another aspect of the present invention is directed to a mating connector adapted to be connected to a on-board connector which is mounted on a substrate on which a heat generating element is provided at a position near the on-board connector, the on-board connector comprising a plurality of terminals, a connector housing which houses the terminals, and a shield case which covers part or all of the heat generating element. The mating connector comprises a plurality of terminals which are adapted to be connected to the terminals of the on-board connector when the mating connector is connected to the on-board connector; a connector housing which houses the terminals; a metallic shield which is adapted to be in contact with the shield case of the on-board connector when the mating connector is connected to the on-board connector; and a connector cable connected to the terminals of the mating connector, the connector cable having a braided shield which is electrically connected to the metallic shield.

According to the mating connector having the structure described above, since the metallic shield of the mating connector is in contact with the shield case of the on-board connector when these connectors are connected, the heat generated in the heat generating element is diffused to the metallic shield of the mating connector and further diffused to the braided shield through the metallic shield of the mating connector, thereby enabling to further increase the heat radiating effect.

The other aspect of the present invention is directed to a connector apparatus having a first connector to be mounted on a substrate on which a heat generating element is provided and a second connector adapted to be connected to the first connector, wherein the first connector comprises a plurality of first terminals, a connector housing which houses the first terminals, and a shield case which covers part or all of the heat generating element; and the second connector comprises a plurality of second terminals which are adapted to be connected to the first terminals of the first connector when the second connector is connected to the first connector, a connector housing which houses the second terminals, a metallic shield which is adapted to be in contact with the shield case of the first connector when the second connector is connected to the first connector, and a connector cable connected to the second terminals, the connector cable having a braided shield which is electrically connected to the metallic shield.

Yet other aspect of the present invention is directed to an on-board type connector apparatus comprising a substrate having a heat generating element thereon, a first connector mounted on the substrate at a position near the heat generating element, and a second connector connected to the first connector. The first connector comprises a plurality of first terminals, a connector housing which houses the first terminals, and a shield case which covers part or all of the heat generating element. The second connector comprises a plurality of second terminals which are connected to the first terminals of the first connector when the second connector is connected to the first connector, a connector housing which houses the second terminals, a metallic shield which is in contact with the shield case of the fist connector when the second connector is connected to the first connector, and a connector cable connected to the second terminals of the second connector, the connector cable having a braided shield which is electrically connected to the metallic shield.

These and other objects, operations and effects of the present invention will be apparent when the following description of the preferred embodiment will be considered taken in conjunction with the attached drawings.

### BRIEF DESCRIPTION OF THE DRAWINGS

FIG. 1 is a perspective view showing the overall structure of a connector socket and a connector plug according to an embodiment of the present invention.

FIG. 2 is a perspective view showing the overall structure of a prior art connector socket and a prior art connector plug.

### DETAILED DESCRIPTION OF THE INVENTION

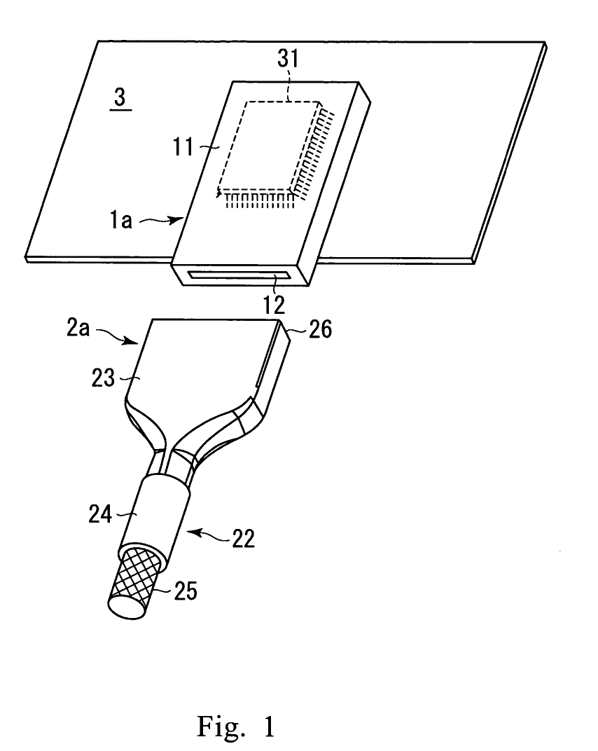

The preferred embodiment of an on-board connector, a mating connector, and a connector apparatus equipped with the on-board connector and the mating connector according to the present invention is described below with reference to FIG. 1.

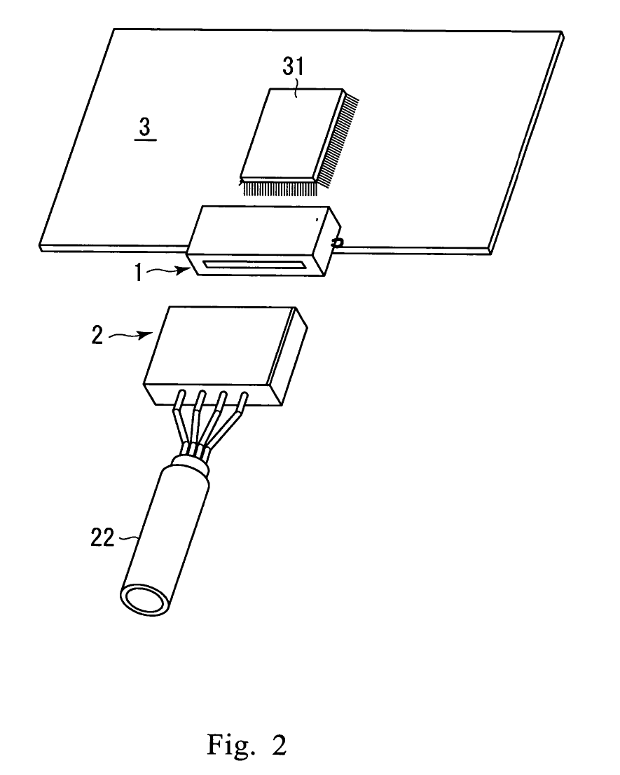

In the connector apparatus according to the present invention, the “on-board connector” or “first connector” is described as a connector socket 1a, and the “mating connector” or “second connector” is described as a connector plug 2a, but the socket and plug relationship may be reversed, or any male type and female type connectors may be used so long as a mutual connection is possible. Further, in the present invention, the combination of a substrate having a heat generating element thereon, the on-board connector provided on the substrate and the mating connector connected to the on-board connector is referred to as an on-board type connector apparatus. Furthermore, in this specification, the same reference numbers will be used for the elements in FIG. 1 having the same function as those elements shown in FIG. 2.

In this embodiment, the connector socket 1a includes a shield case 11 that extends from an end portion of a substrate 3 to an IC 31 mounted on the substrate 3, and a connector housing (not shown in the drawing) provided with a plurality of terminals and arranged inside the shield case 11. Further, FIG. 1 shows a socket opening 12 of the connector housing.

The IC 31 is a heat generating element such as a CPU or a motor driver IC or the like which generates high heat.

The shield case 11 is formed from a metal plate made of steel or aluminum or the like. The shield case 11 is integrally formed with the connector housing. Alternatively, the shield case 11 is separately formed from the connector housing and provided in contact with the connector housing. In addition to covering the connector housing, the shield case 11 extends to the rear and covers the top and sides of the IC 31. Further, silicon grease which is used when the heat generating element is mounted to a heat radiator is applied to the underside of the shield case 11 and the top of the IC 31 to create a heat connection between the shield case 11 and the IC 31 for increasing the heat transfer efficiency therebetween.

Further, the shield case 11 is soldered to the ground on top of the substrate 3. In this way, it is possible to form an electromagnetic shield for the electromagnetic waves generated from the IC 31 and directed to the IC 31.

On the other hand, the connector plug 2a includes a plug portion 26, and a plug shield 23 provided the outside of the connector plug 2a. The inside of the plug portion 26 is provided with terminals or terminal pins (not shown in the drawings) adapted to make contact with the terminals of the connector housing of the connector socket 1a. Further, a connector cable 22 is connected to the connector plug 2a, and a caulk 24 is provided at the connection portion therebetween. Further, a braided shield 25 is provided on the connector cable 22.

The plug shield 23 is also formed from a metal plate made of steel or aluminum or the like. Further, when the plug portion 26 of the connector plug 2a is connected to the socket opening 12 of the connector socket 1a, a connection is made in which the end portion of the plug shield 23 overlaps the end portion of the shield case 11. The caulk 24 is also formed from a metal plate made of steel or aluminum or the like, and is provided to clad the cable side end portion of the plug shield 23 and the end portion of the braided shield 25. Further, the braided shield 25 is grounded.

Next, the operation of the connector socket 1a and the connector plug 2a will be described.

The heat generated from the IC 31 is transmitted first to the shield case 11 of the connector socket 1a. In the case where the surface area or the heat capacity of the shield case 11 is large, it is possible to ensure sufficient heat radiating performance only by the shield case 11. Further, in the present embodiment, because the connector socket 1a makes contact with the substrate 3 over a wide area, it is possible to increase the mounting strength of the connector socket 1a with respect to the substrate 3. Further, because the shield case 11 is soldered to the ground of the substrate 3, the shield case 11 also functions as an electromagnetic shield.

Next, in the state where the connector socket 1a is connected to the connector plug 2a, the heat of the shield case 11 is transmitted to the plug shield 23, and this makes it possible to further increase the heat radiating effect. Further, because the plug shield 23 is provided on the outside of the connector plug 2a, the heat radiating performance is high. Namely, even in the case where the connector socket 1a is arranged in a closed casing of a personal computer or the like, because the connector plug 2a is positioned outside the casing, it is possible to increase the heat radiating effect.

Further, the heat of the plug shield 23 is transmitted to the braided shield 25 clad by the caulk 24. Because the braided shield 25 extends along the connector cable 22, the braided shield 25 has sufficient heat capacity, and this makes it possible to carry out efficient heat diffusion.

Further, because the shield case 11 that covers the IC 31 is electrically connected to the braided shield 25 via the plug shield 23, this connection functions as an additional electromagnetic shield of the IC 31.

In the present embodiment, the connector socket 1a is arranged along the longitudinal direction of the IC 31. However, because the object of the present invention is to achieve heat radiation and an electromagnet shield for the IC 31 as described above, the configuration and shape of these elements does not matter. For example, in the case where the IC is arranged at a side of the on-board connector, it is possible to use a shield case that is long in the side direction.

Furthermore, in accordance with the amount of heat radiation or electromagnetic shielding required, the area of the IC 31 covered by the shield case 11 can be suitably adjusted, and the area of the plug shield 23 can be restricted. For example, the shield case 11 may be configured so as to cover part or all of the IC 31.

Finally, it should be understood that the present invention is not limited to the embodiment described above, and it is possible to make various changes and improvements without departing from the scope and spirit of the invention defined in the appended claims.

1. An on-board connector which is adapted to be mounted on a substrate on which at least one heat generating element is provided near a position where the on-board connector is to be mounted, the on-board connector comprising:
a plurality of terminals;
a connector housing which houses the terminals; and
a shield case which covers part or all of the heat generating element when the connector is mounted on the substrate.

2. The on-board connector as claimed in claim 1, wherein the shield case is formed from a metallic material, and the shield case is integrally formed with the connector housing.

3. The on-board connector as claimed in claim 1, wherein the shield case is formed from a metallic material as a separate component from the connector housing, and the shield case is provided in contact with the connector housing.

4. A mating connector adapted to be connected to a on-board connector which is mounted on a substrate on which a heat generating element is provided at a position near the on-board connector, the on-board connector comprising a plurality of terminals, a connector housing which houses the terminals, and a shield case which covers part or all of the heat generating element, the mating connector comprising:
a plurality of terminals which are adapted to be connected to the terminals of the on-board connector when the mating connector is connected to the on-board connector;
a connector housing which houses the terminals;
a metallic shield which is adapted to be in contact with the shield case of the on-board connector when the mating connector is connected to the on-board connector; and
a connector cable connected to the terminals of the mating connector, the connector cable having a braided shield which is electrically connected to the metallic shield.

5. A connector apparatus having a first connector to be mounted on a substrate on which a heat generating element is provided and a second connector adapted to be connected to the first connector, wherein:
the first connector comprises a plurality of first terminals, a connector housing which houses the first terminals, and a shield case which covers part or all of the heat generating element; and
the second connector comprises a plurality of second terminals which are adapted to be connected to the first terminals of the first connector when the second connector is connected to the first connector, a connector housing which houses the second terminals, a metallic shield which is adapted to be in contact with the shield case of the first connector when the second connector is connected to the first connector, and a connector cable connected to the second terminals, the connector cable having a braided shield which is electrically connected to the metallic shield.

6. The connector apparatus as claimed in claim 5, wherein the shield case of the first connector is formed from a metallic material, and the shield case is integrally formed with the connector housing of the first connector.

7. The connector as claimed in claim 5, wherein the shield case of the first connector is formed from a metallic material as a separate component from the connector housing of the first connector, and the shield case is provided in contact with the connector housing of the first connector.

8. An on-board type connector apparatus, comprising
a substrate having a heat generating element thereon;
a first connector mounted on the substrate at a position near the heat generating element; and
a second connector connected to the first connector,
wherein the first connector comprises a plurality of first terminals, a connector housing which houses the first terminals, and a shield case which covers part or all of the heat generating element; and
the second connector comprises a plurality of second terminals which are connected to the first terminals of the first connector when the second connector is connected to the first connector, a connector housing which houses the second terminals, a metallic shield which is in contact with the shield case of the fist connector when the second connector is connected to the first connector, and a connector cable connected to the second terminals of the second connector, the connector cable having a braided shield which is electrically connected to the metallic shield.
